(19) United States
(12) Patent Application Publication
(10) Pub. No.: US 2018/0333842 A1
(43) Pub. Date: Nov. 22, 2018

(54) Autonomous Control of an Extendable Apparatus

(71) Applicant: onCue Strategies, Boulder Creek, CA (US)

(72) Inventor: John McEntee, Boulder Creek, CA (US)

(21) Appl. No.: 15/530,176

(22) PCT Filed: Jun. 8, 2015
(86) PCT No.: PCT/US2015/034744

§ 371 Date: Dec. 9, 2016

(51) Int. Cl. B25J 9/00; B25J 13/08

(52) U.S. Cl. CPC B25J 9/0066; F16H 25/2204; B25J 13/085

(57) ABSTRACT

In an example, an apparatus may include a first elongated member having a hollow core and a first end, a second elongated member extending partially into the hollow core of the first elongated member, a driving mechanism to move the first elongated member with respect to the second elongated member to vary a distance between the first end and the second elongated member, and a control circuit housed within the second elongated member, in which the control circuit is to control the driving mechanism to vary a position of the first end with respect to the second elongated member. The apparatus may also include a load cell to detect a physical load applied onto the apparatus, in which the load cell is to communicate the detected physical load to the control circuit.

### CROSS-REFERENCE TO RELATED APPLICATIONS

This application claims the benefit of priority to U.S. Provisional Application No. 62/009,840, filed on Jun. 9, 2014, entitled “Autonomous Elements Especially Suitable for Automation Platforms,” the disclosure of which is hereby incorporated by reference in its entirety. This application also shares some subject matter with co-pending U.S. patent application Ser. No. 14/082,160, filed on Nov. 17, 2013, entitled “Rotary to Linear Transmission,” the disclosure of which is hereby incorporated by reference in its entirety.

### BACKGROUND

Robotic platforms or simply robotics are often employed in a wide array of manufacturing technologies including automobile manufacturing and circuit chip fabrication to name just a couple. Although robotic platforms typically enhance manufacturing processes, fabrication and operation of the robotic platforms themselves is often very expensive and requires a highly skilled workforce. As a result, the use of robotics is mostly limited to special, high-value applications, where production quantities, product value, extreme precision, safety, or where other special factors are involved.

### BRIEF DESCRIPTION OF THE DRAWINGS

Features of the present disclosure are illustrated by way of example and not limited in the following figure(s), in which like numerals indicate like elements, in which:

FIG. 1A shows a perspective view of an apparatus, according to an example of the present disclosure;

FIGS. 1B and 1C, respectively, show exploded views of a first elongated member and a second elongated member of the apparatus depicted in FIG. 1A, according to an example of the present disclosure;

FIG. 2A shows a side view of the apparatus depicted in FIG. 1, partially in cross-section, according to an example the present disclosure;

FIGS. 2B and 2C, respectively, show an electrically conductive coil and a combination of an electrically conductive coil and a first elongated member, which may be used as a position sensor, according to an example of the present disclosure;

FIG. 3 shows a block diagram of the apparatus depicted in FIGS. 1A and 2A, according to an example of the present disclosure;

FIGS. 4A-4B, 5, and 6A-6B, respectively, show diagrams of systems that may include a plurality of the apparatuses depicted in FIG. 1A, according to examples of the present disclosure;

FIG. 7 shows a schematic diagram of a control system for the control circuits in a plurality of the apparatuses depicted in FIG. 1A, according to an example of the present disclosure; and

FIGS. 8 and 9, respectively show flow diagrams of methods and for controlling an apparatus having a first member and a second member, in which the second member is partially inserted into the first member as shown in FIG. 1A, according to two examples of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein is an apparatus, which is also referred to herein as a strut, that includes a first elongated member and a second elongated member. The first elongated member is also referred to herein as a first member and the second elongated member is also referred to herein as a second member. Generally, speaking, the second member is partially inserted into the first member and the depth of the partial insertion may be controlled by a control circuit and a driving mechanism. That is, the control circuit, which may be contained in the apparatus, may control the driving mechanism to cause the first member to either cover more or less of the second member, thereby varying the length of the apparatus. In one example, the control circuit may receive instructions from an external controller and may execute the instructions in an autonomous manner, i.e., may execute the instructions without further instructions from the external controller. In another example, the control circuit may learn a particular routine to follow through recording of detected movements of the apparatus over a time period. In this example, the control circuit may execute the learned routine to repeat the training routine and perform a desired function.

According to an example, first ends of a plurality of the apparatuses may be rotatably connected to a first mount and second ends of the apparatuses may be connected to a second mount through the use of, for instance, clevis joints. In addition, each of the apparatuses may operate independently of each other, such that, the lengths of the apparatuses may vary from each other over various time periods. In this regard, an end effector attached to the first mount may be moved to desired positions in three-dimensional space by appropriately varying the lengths of the apparatuses. For instance, when at least six apparatuses are rotatably connected to the first mount and the second mount, the end effector attached to the first mount may be maneuvered with six degrees of freedom. In operation, the control circuits in the apparatuses may function as a parallel processing system that holistically controls and coordinates the motions of a resulting mechanism without the need for an external controller.

In one implementation, the apparatuses may be employed in a robotics platform, for instance, as a platform that is to maneuver a robotic arm to desired positions and orientations over a period of time. As each of the apparatuses includes a respective control circuit and is therefore able to operate in an autonomous manner, the robotic platforms implementing the apparatuses disclosed herein may be fabricated and programmed in a relatively simpler manner than is possible with conventional fabrication and programming techniques. In one regard, the apparatuses disclosed herein may enable the creation of a massively configurable platform for the creation of motion products.

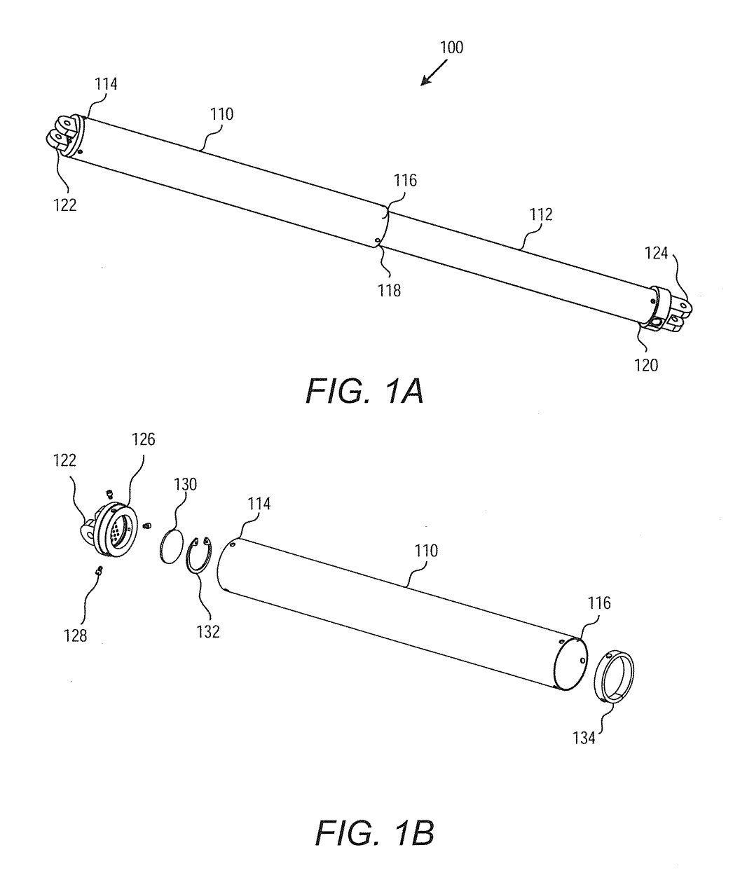

With reference first to FIG. 1A, there is shown a perspective view of an apparatus 100, according to an example of the present disclosure. It should be understood that the apparatus 100 depicted in FIG. 1A may include additional components and that some of the components described herein may be removed and/or modified without departing from a scope of the apparatus 100.

As shown in FIG. 1A, the apparatus 100, which is also referred to herein as a strut, is depicted as including a first elongated member 110 and a second elongated member 112. The second elongated member 112 is depicted as having a relatively smaller diameter as compared with the first elongated member 110 and being inserted or fitted within the first elongated member 110. Particularly, the first elongated member 110 may have a hollow or tubular structure having a first end 114 and a second end 116, in which a first end 118 of the second elongated member 112 is inserted into the second end 116 of the first elongated member 110. In addition, the first end 118 of the second elongated member 112 may be arranged to be in a sliding relationship with the first elongated member 110 to enable the length of the apparatus 100 to be varied. Both of the first elongated member 110 and the second elongated member 112 may be formed of a relatively rigid material such as metal, plastic, composite material, etc.

As described in greater detail herein below, the apparatus 100 includes a driving mechanism that moves the first elongated member 110 linearly with respect to the second elongated member 112. The apparatus 100 also includes a control circuit that controls the driving mechanism and thus controls the length of the apparatus 100. In one regard, the control circuit may follow a programmed routine to thus enable the apparatus 100 to be extended to different lengths at different points in time. The apparatus 100 may learn the programmed routine through receipt of physical movement inputs or may receive the programmed routine. In either of these examples, the apparatus 100 may perform the programmed routine without requiring receipt of external commands.

The driving mechanism may be provided in the second elongated member 112 and actuation of the driving mechanism may cause the first elongated member 110 to move linearly with respect to the second elongated member 112. By way of particular example, the first elongated member 110 may be a track tube element and the second elongated member 112 may be a motor tube element, in which the rotation of the drive mechanism in the motor tube element causes linear motion of the track tube element.

In FIG. 1A, a first attachment device 122 is depicted as being positioned on the first end 114 of the first elongated member 110 and a second attachment device 124 is depicted as being positioned on a second end 120 of the second elongated member 112. The first attachment device 122 and the second attachment device 124 may be clevis devices that are to attach to clevis mounts or connectors (not shown). Particularly, the first attachment device 122 and the second attachment device 124 may enable the apparatus 110 to be movably attached to clevis mounts or connectors.

Turning now to FIGS. 1B and 1C, there are respectively shown exploded views of the first elongated member 110 and the second elongated member 112 of the apparatus 100 depicted in FIG. 1A, according to an example of the present disclosure. The first elongated member 110 is depicted in FIG. 1B as having a hollow core and may thus receive the second elongated member 112. The first attachment member 122 is depicted as having a base section 126 that is to be fastened to the first end 114 of the first elongated member 110 via screws 128.

As shown in FIG. 1B, the base section 126 may be perforated to enable air to flow into and out of the first elongated member 110, as may be necessary to enable the first elongated member 110 to move linearly with respect to the second elongated member 112. A filter disk 130, which may be retained on the base section 126 by a snap ring 132, for instance, to prevent dust or other air-born particulates from being drawn into the apparatus 100, is also shown in FIG. 1B. Also shown is a stop sleeve 134 attached to the second end 116 of the first elongated member 110. The stop sleeve 134 may be attached to the first elongated member 110 through any suitable fastening mechanism, such as, screws, glue, posts, threads, etc. In any regard, the stop sleeve 134 may support the second elongated member 112 as the first elongated member 110 is moved with respect to the second elongated member 112. The stop sleeve 134 may also prevent or otherwise restrict the second elongated member 112 from being removed from within the first elongated member 110. In this regard, the stop sleeve 134 may be inserted into the second end 116 of the first elongated member 110 concurrently with the first end 118 of the second elongated member 112.

The second elongated member 112 is depicted in FIG. 1C as having a hollow core, in which, a driving mechanism 140 may be provided at the first end 118 of the second elongated member 112. The driving mechanism 140 may be fastened to the first end 118 of the second elongated member 112 by screws 142. However, the driving mechanism 140 may additionally or alternatively be attached to the second elongated member 112 through use of glue, welds, pins, rivets, swagings, etc. The driving mechanism 140 is depicted as including a motor 144 and a plurality of balls 146. As described in U.S. patent application Ser. No. 14/082,160, the plurality of balls 146 may contact an inner surface of the first elongated member 110 and rotation of the plurality of balls 146 by the motor 144 causes the first elongated member 110 to move linearly with respect to the second elongated member 112. In this regard, the length of the apparatus 110 may be varied by causing the motor 144 to rotate the plurality of balls 146 in one direction or the other. t

Although particular reference is made in the present disclosure to the driving mechanism 140 having the features of the rotary to linear motion apparatus described in U.S. patent application Ser. No. 14/082,160, it should be understood that other suitable driving mechanisms may be employed in the apparatus 100 without departing from a scope of the apparatus 100. For instance, the driving mechanism 140 may have a ball screw or other mechanical device for varying the position of the first elongate member 110 with respect to the second elongate member 112.

Also depicted in FIG. 1C are a control circuit 150 and a load cell 152. Various functionalities of the control circuit 150 and the load cell 152 are described in detail below. In any regard, the control circuit 150 is depicted as being supportable by an end cap 154 that is to be inserted into the second end 120 of the second elongated member 112. Additionally, the end cap 154 may be fastened to the second end 120 via screws 156. The load cell 152 may be positioned between the second attachment device 124 and the end cap 154. In this regard, the load cell 152 may detect loads being applied on the entire apparatus 100, e.g., the load cell 152 may detect tension and/or compression between the ends of the apparatus 100. The second attachment device 124 and the load cell 152 may be fastened to the end cap 154 via screws 160. According to an example, the second attachment device 124 may also include features to enable an electrical connection to be established with a mating device, e.g., a mounting element, such that power and/or data may be communicated through the second attachment device 124 and to the control circuit 150. Power may also be supplied to the load cell 152 through the second attachment device 124. Alternatively, however, power and/or data may be provided through a wire supplied through the end cap 154.

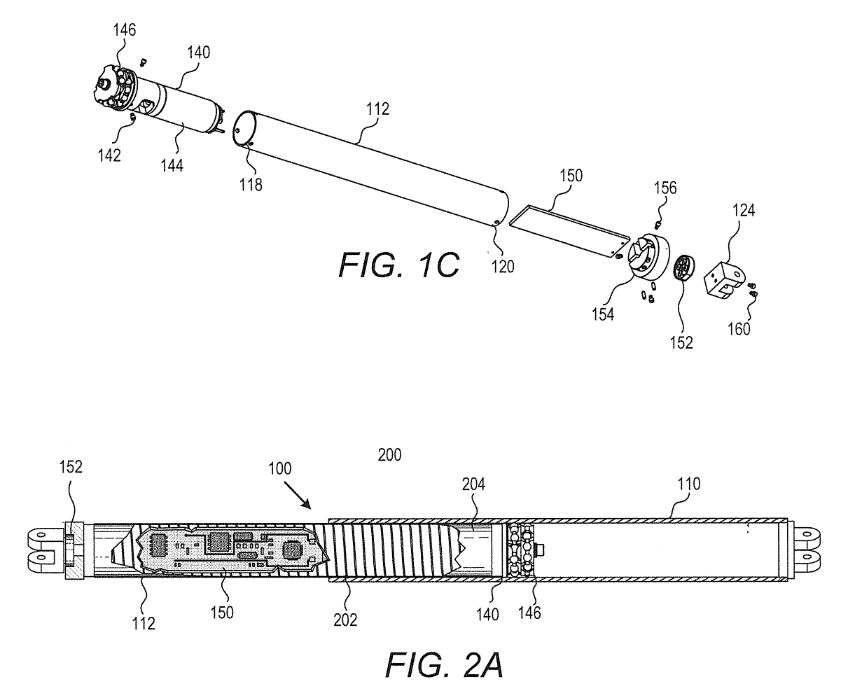

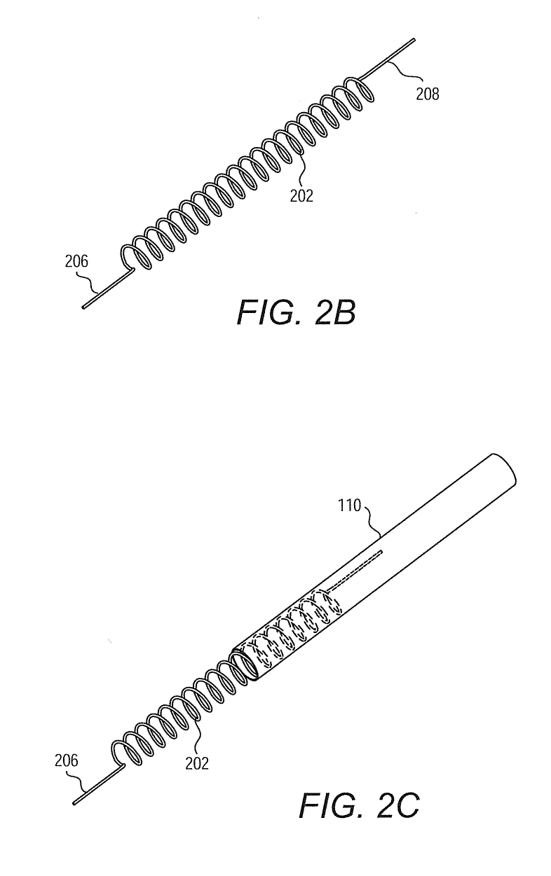

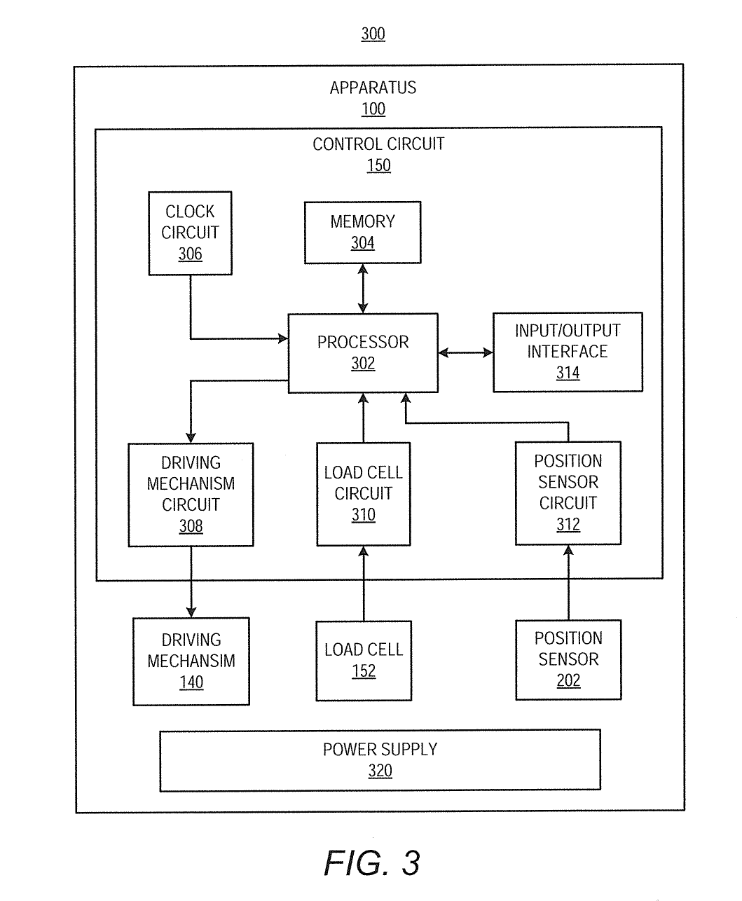

Turning now to FIG. 2A, there is shown a side view 200 of the apparatus 100 depicted in FIG. 1, partially in cross-section, according to an example the present disclosure. The side view 200 shows that a portion of the second elongated member 112 extends into a portion of the first elongated member 110. Additionally, the length of the apparatus 100 may be varied through rotation of the plurality of balls 146 in the driving mechanism 140 as discussed above. Particularly, rotation of the plurality of balls 146 may cause the first elongated member 110 to move linearly with respect to the second elongated member 112. The side view 200 also shows that the control circuit 150 contains a number of components on a board, such as, a printed circuit board. The components of the control circuit 150 are described in greater detail herein below with respect to FIG. 3.

Although not particularly shown in FIG. 2A, the driving mechanism 140 and the load cell 152 may be electrically connected to the control circuit 150. As also described in greater detail herein below with respect to FIG. 3, the control circuit 150 may receive signals corresponding to loads detected by the load cell 152 and a control operation of the driving mechanism 140. That is, for instance, the load cell 152 may detect tensile or compressive forces as the extension or retraction of the apparatus 100 is resisted as force is applied on the first attachment device 122 and the second attachment device 124.

As shown in FIG. 2A, the apparatus 100 may include a position sensor 202 to detect the position of the first elongated member 110 with respect to the second elongated member 112. That is, the position sensor 202 may track and detect the relative movement of the first elongated member 110 with respect to the second elongated member 112. As shown in FIG. 2A, the position sensor 202 may include an electrically conductive coil that is positioned between the first elongated member 110 and the second elongated member 112, such that electrically conductive coil extends for a major distance along the length of the second elongated member 112. In addition, an insulating sleeve 204 may be provided between the electrically conductive coil 202 and the first elongated member 110. An example of the electrically conductive coil 202 is depicted in FIG. 2B and an example of the electrically conductive coil 202 and the first elongated member 110 is depicted in FIG. 2C.

The electrically conductive coil 202 may be excited with an alternating current supplied between a first end 206 and a second end 208 of the electrically conductive coil 202. When the first elongated member 110, which may be formed of a ferromagnetic material, is moved over the electrically conductive coil 202, the alternating current in the electrically conductive coil 202 induces an alternating magnetic field in the first elongated member 110. The inductance of the electrically conductive coil 202 may be varied as the first elongated member 110 covers more or less of the electrically conductive coil 202. The level of inductance of the electrically conductive coil 202 may thus be measured to determine the position of the first elongated member 110 with respect to the second elongated member 112. That is, the control circuit 150 may be programmed with a correlation between the inductance level of the electrically conductive coil 202 and the position of the first elongated member 110 with respect to the second elongated member 112.

Although particular reference is made in the present disclosure to the position sensor 202 being formed of an electrically conductive coil and that an inductance level in the electrically conductive coil is measured to determine the position of the first elongated member 110, it should be understood that other suitable position sensors, such as sensors that employ an encoder, or a laser, etc., may be employed in the apparatus 100 without departing from a scope of the apparatus 100.

With reference now to FIG. 3, there is shown a block diagram 300 of the apparatus 100 depicted in FIGS. 1A and 2A, according to an example. It should be understood that the apparatus 100 depicted in FIG. 3 may include additional components and that some of the components described herein may be removed and/or modified without departing from a scope of the apparatus 100.

Similarly to FIGS. 1A and 2A, the apparatus 100 is depicted in FIG. 3 as including the control circuit 150, the driving mechanism 140, the load cell 152, and the position sensor 202. The control circuit 150 is also depicted as including a processor 302, a memory 304, a clock circuit 306, a driving mechanism circuit 308, a load cell circuit 310, the position sensor circuit 312, and an input/output interface 314.

The processor 302 may be one or more central processing units (CPUs), semiconductor-based microprocessors, an application specific integrated circuit (ASIC), and/or other hardware devices suitable for retrieval and execution of instructions stored in the memory 304, which may be a non-transitory machine-readable storage medium. The processor 302 may fetch, decode, and execute instructions stored in the memory 304 to instruct the driving mechanism circuit 308 to control operation of the driving mechanism 140.

The memory 304 may be any electronic, magnetic, optical, or other physical storage device that contains or stores executable instructions. Thus, the memory 304 may be, for example, Random Access Memory (RAM), an Electrically Erasable Programmable Read-Only Memory (EEPROM), a storage device, and the like. In some implementations, the memory 304 may be a non-transitory storage medium, where the term “non-transitory” does not encompass transitory propagating signals.

According to an example, the processor 302 may instruct the driving mechanism circuit 308 to cause the driving mechanism 140, i.e., control delivery of power to the driving mechanism 140, to vary the position of the first elongated member 110 in response to receipt of a load on the apparatus 100 by the load cell 152. In this example, the position sensor 202 may measure a tensile or compressive force being applied onto the apparatus 100 and may communicate the measured force to the load cell circuit 310. The load cell circuit 310 may communicate the measured force to the processor 302, and the processor 302 may determine, for instance, based upon programmed instructions stored in the memory 304, how the driving mechanism 140 is to be operated responsive to the measured force.

By way of example, if the measured force is a compressive force, the processor 302 may determine that the length of the apparatus 100 is to be reduced and may therefore send an instruction to the driving mechanism circuit 308 to cause the driving mechanism 140 to reduce the length of the apparatus 100 by linearly moving the first elongated member 110 to cover more of the second elongated member 112. In addition, the processor 302 may determine not send the instruction to the driving mechanism circuit 308 unless the measured load exceeds a predetermined threshold, for instance, a load that is greater than the weight of the apparatus 100 itself, a load corresponding to an extraneous movement, etc. In any regard, the processor 302 may instruct the driving mechanism circuit 308 to continue moving the first elongated member 110 until the load cell 152 stops communicating a measured force or when the first elongated member 110 has reached a stop point.

According to an example, the processor 302 may track or record various forces that the load cell 152 detects over time and may generate a routine from the tracked forces. For instance, a user may train the processor 302 to cause the first end 114 of the first elongated member 110 to move to a plurality of positions at various times by physically moving the first end 114 of the first elongated member 110 to the plurality of positions at predetermined times. That is, a user may train the processor 302 by physically moving the first end 114 in the manner that the user desires and the processor 302 may develop a routine based on the loads detected by the load cell 152 of the movements over time and may store the routine in the memory 304. The processor 302 may then cause the driving mechanism 140 to perform the routine. That is, the processor 302 may instruct the driving mechanism circuit 308 to control the driving mechanism 140 to vary the position of the first elongated member 110 to different positions according to the timing at which the first elongated member 110 was moved during the training. The processor 302 may determine the timing from the clock circuit 306 and may determine the position of the first elongated member 110 from information received from the position sensor 202 via the position sensor circuit 312.

In the example above, the apparatus 100, and particularly, the processor 302, may operate autonomously as instructions from an external controller (not shown) may not be required for the processor 302 to operate.

In another example, the processor 302 may be programmed to perform a specified routine by an external controller (not shown). For instance, the processor 302 may receive programming instructions from the external controller through the input/output interface 314 and may store the received programming instructions in the memory 304. The processor 302 may also communicate data to the external controller via the input/output interface 314. The input/output interface 314 may include hardware and/or software to enable the processor 302 to communicate with the external controller and/or to other apparatuses 100, as described in greater detail herein below. The input/output interface 314 may enable a wireless connection to the external controller and/or other apparatuses 100, for instance through a peer-to-peer connection such as Wi-Fi, Bluetooth™, etc. The input/output interface 314 may also enable a wired connection to the external controller and/or other apparatuses 100. In this example, power may also be provided to the components of the apparatus 100 through the wired connection. In any regard, the processor 302 may form a network, e.g., a peer-to-peer network, with the processor 302 of another apparatus 100.

Alternatively, however, the components of the apparatus 100 may receive power through a separate power supply 320. For instance, the power supply 320 may include a wired connection to a power source that is external to the apparatus 100. In another example, the power supply 320 may be a battery, such as a rechargeable battery that is provided within the apparatus 100. In a further example, the power supply 320 may be a combination of a wired connection to a power source and an internal battery. By way of example, the internal battery may operate to supply supplemental power to the wired connection to the power source, for instance, when additional power is needed by the apparatus 100.

In a particular example, the apparatus 100 is to communicate with other apparatuses 100 such that the apparatuses 100 may share data and operate in a coordinated manner. In this example, the apparatuses 100 may communicate with each other over a field bus connection or via any of the wireless communications techniques discussed above. The apparatuses 100 may communicate various types of data to each other, for instance, if one of the apparatuses 100 detects a problem, that apparatus 100 may communicate that information to the other apparatuses 100 such that all of the apparatuses 100 cease their operations.

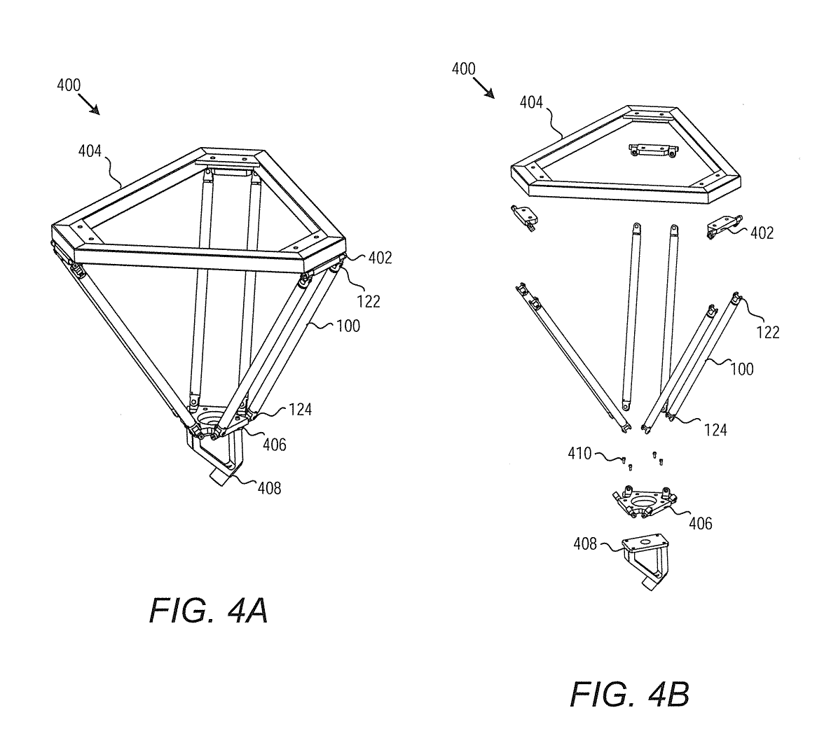

According to an example, the apparatus 100 may be connected to at least one other apparatus 100 via a connector and the apparatuses 100 may operate together. That is, the first attachment device 122 of one apparatus 100 may be connected to a first part of an end effector and the first attachment device 122 of another apparatus 100 may be connected to another part of the end effector. In addition, each of the apparatuses 100 may operate separately from each other. For instance, one of the apparatuses 100 may be extended while the other one of the apparatuses 100 may be retracted. In this regard, the position, orientation, and the angle of the end effector may be varied by varying the lengths of the apparatuses 100. Various examples of systems of apparatuses 100 are described with respect to FIGS. 4A-4B, 5, and 6A-6B. In an example, each of the apparatuses 100 connected to the same end effector may be programmed to operate independently of each other and to follow different programs, such that the end effector may be moved to different positions, orientations, and angles through the independent operations. However, the independent operations may result in the end effector being positioned at a desired position.

With reference first to FIGS. 4A and 4B, there are respectively shown a schematic diagram and an exploded diagram of a system 400 that includes six apparatuses 100. In the system 400, the six apparatuses 100 are arranged in pairs, in which the first attachment devices 122 of each pair of apparatuses 100 is connected to a respective clevis mount 402. Each of the clevis mounts 402 is also depicted as being attached to a frame 404. In addition, each of the second attachment devices 124 are depicted as being connected to a base clevis mount 406. The base clevis mount 406 is further depicted as being attached to an end effector 408 via screws 410.

The system 400 depicted in FIGS. 4A and 4B may be implemented as an automation platform, which has six degrees of freedom, for instance, in the X, Y, Z directions as well as roll, pitch, and yaw. In other words, the system 400 may be implemented as a manipulator for a robotic device, in which the position of the end effector 408 may be varied over time. That is, each of the apparatuses 100 may be programmed in any of the manners described above such that each of the apparatuses 100 follows an individual programmed routine. By carrying out the individually programmed routines, the end effector 408 may be moved to a first predetermined position at a first time, a second predetermined position at a second time, etc. As discussed above, the apparatuses 100 may each learn their individual routines through recording movement of the apparatus 100 as a user moves the end effector 408 at multiple instances of time. In this example, the programmed routines may be performed by repeating the learned movements at appropriate corresponding instances in time.

In one example, therefore, each of the apparatuses 100 may operate autonomously from the other apparatuses 100 in the system 400. Additionally, the apparatuses 100 may not be in communication with each other. In other examples, however, the apparatuses 100 may communicate with each other through respective input/output interfaces 314. As described above with respect to FIG. 3, the processors 302 may communicate with each other through wired or wireless communications techniques. By way of example, the processor 302 in one of the apparatuses 100 may be programmed to inform another processor 302 in another one of the apparatuses 100 when a particular movement has been completed. Another processor 302 may then perform its operation and may inform a further processor 302 in a further one of the apparatuses 100 that its operation has been completed. In this example, the processors 302 may operate in a coordinated, sequential, manner with respect to each other through communications with each other.

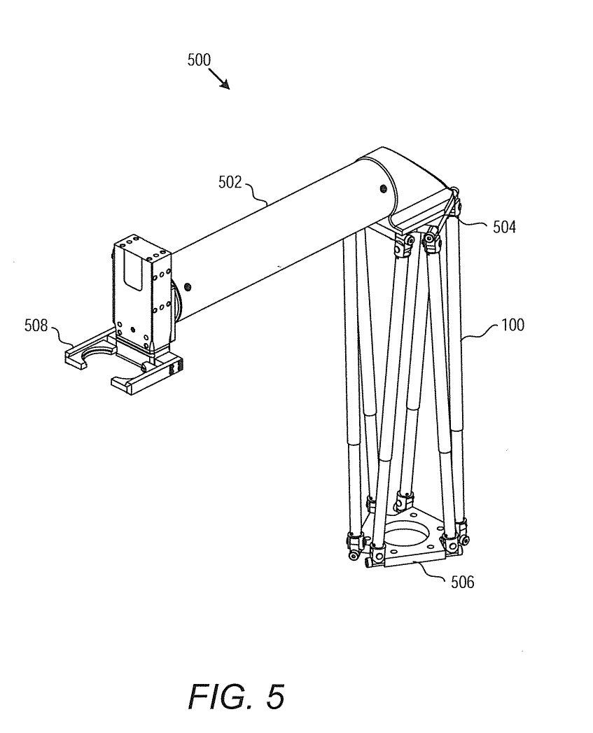

With reference now to FIG. 5, there is shown a schematic diagram of a system 500 that includes a plurality of apparatuses 100 arranged a control the position of a robotic arm 502. The plurality of apparatuses 100 may be connected to the respective clevis mounts 504, 506 in similar manners to those shown in FIGS. 4A and 4B. A top clevis mount 504 is depicted as being attached to the robotic arm 502. The bottom clevis mount 506 may be attached to a stable platform, for instance. In any regard, the apparatuses 100 may be manipulated to provide six degrees of freedom to the positioning of an end effector 508 attached to an end of the robotic arm 502. Each of the apparatuses 100 may be programmed to have various lengths at various moments in time to thus cause the end effector 508 to be moved to predetermined positions according to a preset time schedule.

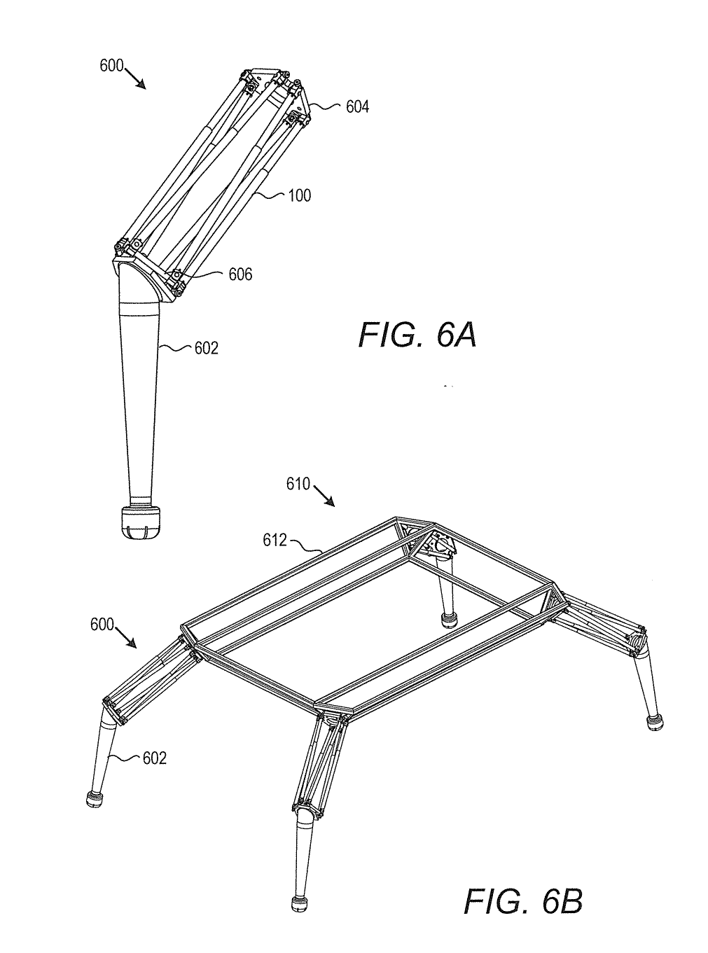

Turning now to FIGS. 6A and 6B, there are respectively shown schematic diagrams of a system 600 that includes a plurality of apparatuses 100 attached to leg 602. The apparatuses 100 contained in the system 600 may be attached to clevis mounts 604 and 606 in manners similar to those described above with respect to FIGS. 4A and 4B. As such, the apparatuses 100 may enable six degrees of freedom in the movement of the leg 602. As shown in FIG. 6B, a walking platform 610 may be formed through attachment of a plurality of the systems 600 to a frame 612. In this example, the walking platform 610 may walk through an appropriate sequential operation of the systems 600. Thus, for instance, in order for the walking platform 610 to walk in a first direction, one of the systems 600 may operate to move one of the legs 602, then another one of the systems 600 may operate to move another one of the legs 602, and so forth. More particularly, the lengths of each of the apparatuses 100 in a first one of the systems 600 may be varied in individual manners to cause the leg 602 of that system 600 to move in a predetermined direction corresponding to the movement of the walking platform 610 in the first direction. Following the movement of the apparatuses 100 in the first one of the systems 600, the apparatuses 100 in a second one of these systems 600 may be varied in individual manners to cause the leg 602 of that system 600 to move in a predetermined direction corresponding to the movement of the walking platform 610 in the first direction. This process may be repeated by the other apparatuses 100 in the remaining systems 600 to cause the walking platform 610 to walk in the first direction.

According to an example, the apparatuses 100 in each of the systems 600 may perform the movements according to the timing of the movements as identified in respective predefined routines for the apparatuses 100. In this example, the apparatuses 100 in the respective systems 600 may not be in communication with the other apparatuses 100 in the other respective systems 600. However, in another example, the apparatuses 100 in a first system 600 may be in communication with the apparatuses 100 in one or more of the other systems 600. In this example, when an apparatus 100 in the first system 600 completes its movement, the processor 302 in that apparatus 100 may communicate an indication to the processors 302 in the apparatuses 100 of the second system 600 that its movement has been completed. The processors 302 in the apparatuses 100 of the second system 600 may initiate movements of the apparatuses 100 of the second system 600 following receipt of the communication. This process may be repeated by the processors 302 in the apparatuses 100 of the second system 600, the third 600, and the fourth system 600. In one regard, therefore, the processors 302 in the apparatuses 100 of all of these systems 600 may work together in response to a single instruction to move the walking platform 610 in any of a number of directions.

As may be seen from the examples described above, the apparatus 100 disclosed herein may be implemented in a variety of different applications. In some applications, the apparatus 100 may operate autonomously with respect to other apparatuses 100 or an external controller. In other applications, the apparatus 100 may operate cooperatively with other apparatuses 100. In any of these applications, the processors 302 in an apparatus 100 may communicate with the processors 302 in the other apparatuses 100.

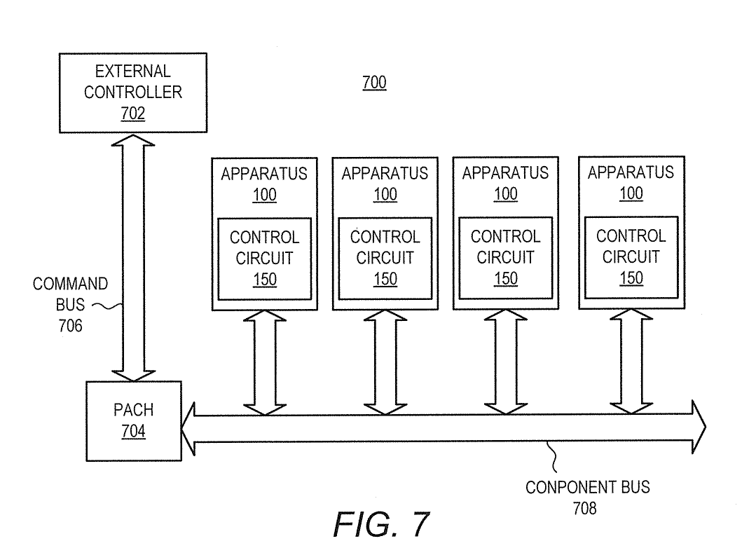

Turning now to FIG. 7, there is shown a schematic diagram of a control system 700 for the control circuits 150 in a plurality of apparatuses 100, according to an example. It should be understood that the control system 700 depicted in FIG. 7 may include additional components and that some of the components described herein may be removed and/or modified without departing from a scope of the control system 700.

As shown in FIG. 7, the control system 700 may include an external controller 702 that may control the control circuits 150 of the plurality of apparatuses 100 as task agents. Particularly, the external controller 702, which may be a computer, a tablet, a server, etc., may parse a program for controlling operations of the individual control circuits into individual control programs, each isolating the functions pertinent to its intended control circuit 150. The external controller 702 may upload the individual control programs to the intended control circuits 150, which may perform or execute the individual control programs, for instance, to cause the apparatuses 100 to operate according to the individual control programs. The external controller 702 may upload the control programs to the control circuits 150 through a command bus 706.

As also shown in FIG. 7, each of the apparatuses 100 may receive power and communications from a power and communication hub (PACH) 704 through a component bus 708. The component bus 708 may create a conduit for the control circuits 150 to broadcast and read cues between each other and these cues may be used for sequencing, synchronization, coordination, etc. In one regard, the control system 700 may be formed as a multi-agent architecture, which may provide an automation environment where a plurality autonomous apparatuses 100 may perform complex coordinated functions and processes with minimal or no central control. That is, once the control circuits 150 are programmed, the control circuits 150 may work autonomously from the external controller 702 to perform programmed operations. In addition, in performing the programmed operations, the control circuits 150 may communicate with each other in order to perform the programmed operations in a sequenced, synchronized, and/or coordinated manner.

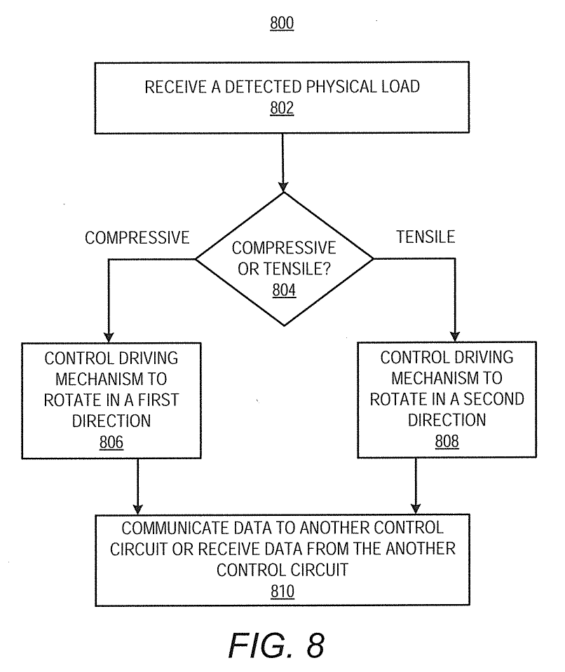

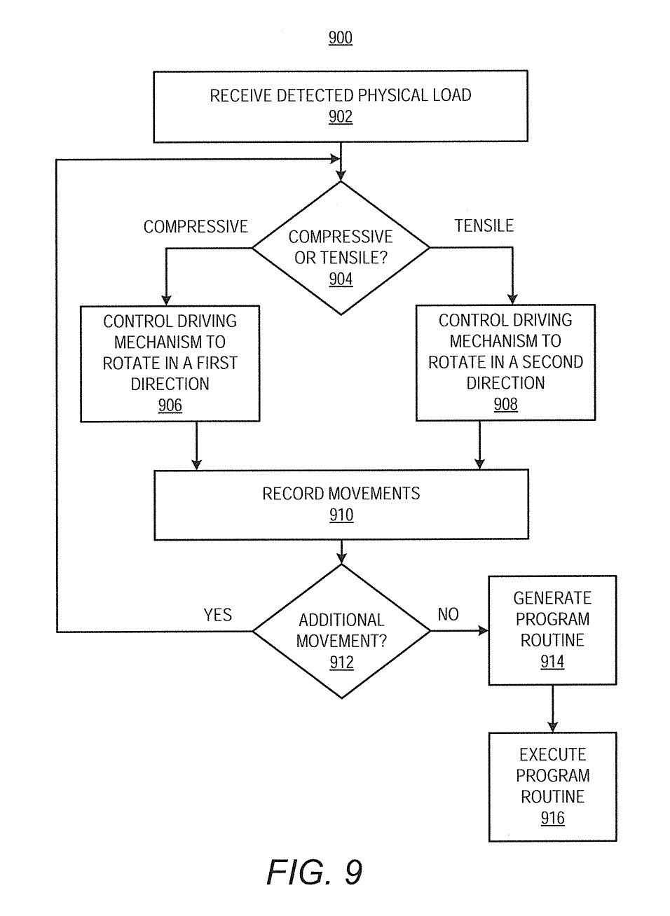

With reference now to FIGS. 8 and 9, there are respectively shown flow diagrams of methods 800 and 900 for controlling an apparatus 100 having a first member 110 and a second member 112 as shown in FIG. 1A, in which the second member is partially inserted into the first member, according to two examples. It should be understood that the methods 800 and 900 depicted in FIGS. 8 and 9 may include additional operations and that some of the operations described herein may be removed and/or modified without departing from the scopes of the methods 800 and 900. The descriptions of the methods 800 and 900 are made with reference to the features depicted in FIG. 3 for purposes of illustration and thus, it should be understood that the methods 800 and 900 may be implemented in apparatuses having architectures different from those shown in that figure.

Generally speaking the control circuit 150, and more particularly, the processor 302 of the control circuit 150, may implement the methods 800, 900. With reference first to FIG. 8, at block 802, the control circuit 150 may receive a detected physical load on the apparatus from a load cell 152. At block 804, the control circuit 150 may determine, for instance, based upon information contained in the detected physical load from the load cell 152, whether the detected physical load is a compressive load or a tensile load. In response to a determination that the detected physical load is a compressive load, the control circuit 150 a control the driving mechanism 140, and more particularly the driving mechanism circuit 308, to cause the driving mechanism 140 to rotate in a first direction, as indicated at block 806. However, in response to a determination that the detected physical load is a tensile load, the control circuit 150 a control the driving mechanism 140, and more particularly the driving mechanism circuit 308, to cause the driving mechanism 140 to rotate in a second direction, as indicated at block 808.

As discussed in greater detail herein above, rotation of the driving mechanism 140 in the first direction may cause the second member 112 to be inserted deeper into the first member 110 and rotation of the driving mechanism 140 in the second direction may cause the second member 112 to be drawn out from the first member 110. In this regard, the control circuit 150 may cause the first member 110 to be moved in the direction in which the physical load is detected to be applied.

At block 810, the control circuit 150 may at least one of communicate data to a second control circuit in a second apparatus and receive data from the second control circuit in the second apparatus to enable the control circuit and the second control circuit to operate in at least one of a sequenced, synchronized, and coordinated manner with each other without external control. In one regard, the control circuit 150 may operate autonomously but in conjunction with another control circuit.

Turning now to FIG. 9, at block 902, the control circuit 150 may receive a detected physical load on the apparatus from a load cell 152. At block 904, the control circuit 150 may determine, for instance, based upon information contained in the detected physical load from the load cell 152, whether the detected physical load is a compressive load or a tensile load. In response to a determination that the detected physical load is a compressive load, the control circuit 150 may control the driving mechanism 140, and more particularly the driving mechanism circuit 308, to cause the driving mechanism 140 to rotate in a first direction, as indicated at block 906. However, in response to a determination that the detected physical load is a tensile load, the control circuit 150 a control the driving mechanism 140, and more particularly the driving mechanism circuit 308, to cause the driving mechanism 140 to rotate in a second direction, as indicated at block 908.

In another example, the control circuit 150 may, in response to the detection of a tensile or compressive force while the driving mechanism 140 is rotating, instruct the driving mechanism 140 to stop rotating. In this example, the control circuit 150 may interpret the detection of the tensile or compressive force as an indication that the apparatus has contacted a surface or object. In one regard, the contact with the surface or object may be an indication of an error and in another regard, the contact with the surface or object may be an indication that an end effector has reached an intended destination, e.g., an object that the end effector is to manipulate.

At block 910, the control circuit 150 may record the movement of the first member 110 at one of blocks 906 and 908. At block 912, the control circuit 150 may determine whether the first member 110 experienced an additional movement, for instance, based upon the determination as to whether a detected physical load was received from the load cell 152 within a predetermined period of time. In response to a determination that an additional movement was experienced, the control circuit 150 may repeat blocks 904-912. In response to a determination that an additional movement was not experienced within the predetermined period of time at block 912, the control circuit 150 may generate a program routine from the recorded movements as indicated at block 914, in which the program routine duplicates the movements and the timing of the movements. At block 916, the control circuit 150 may execute the program routine.

In another example, the control circuit 150 may be programmed, for instance, through input of a keyboard stroke or gesture on an external controller. The programming may be combined with the physical movement of the apparatus 100. In this example, the control circuit 150 may be programmed by an external controller to move to certain waypoints and the control circuit 150 may be programmed through physical movements at the waypoints.

Some or all of the operations set forth in the methods 800 and 900 may be contained as utilities, programs, or subprograms, in any desired computer accessible medium. In addition, the methods 800 and 900 may be embodied by computer programs, which may exist in a variety of forms both active and inactive. For example, they may exist as machine readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a first elongated member having a hollow core and a first end;
a second elongated member extending partially into the hollow core of the first elongated member;
a driving mechanism to move the first elongated member with respect to the second elongated member to vary a distance between the first end and the second elongated member;
a control circuit housed within the second elongated member, wherein the control circuit is to control the driving mechanism to vary a position of the first end with respect to the second elongated member; and
a load cell positioned to detect a physical load applied onto the apparatus, wherein the load cell is to communicate the detected physical load to the control circuit.

2. The apparatus according to claim 1, wherein the control circuit is to control the driving mechanism to follow a programmed routine, wherein the control circuit is to learn a sequence of movements based upon physical loads detected by the load cell over a sequence of time and to program the routine to duplicate the learned sequence of movements over a period of time.

3. The apparatus according to claim 1, wherein the load cell is to detect whether the detected physical load is applied in a first direction or a second direction, and wherein the control circuit is to control the driving mechanism to move the first elongated member in the first direction in response to the detected physical load being applied in the first direction and to control the driving mechanism to move the first elongated member in the second direction in response to the detected physical load being applied in the second direction.

4. The apparatus according to claim 1, further comprising:
a position sensor having a coil that extends around a circumference of the second elongated member, wherein a position of the first elongated member is to vary an inductance of the coil when a current is supplied through the coil, and wherein the control circuit is to determine a position of the first elongated member with respect to the second elongated member based upon the detected inductance of the coil.

5. The apparatus according to claim 4, wherein the control circuit comprises:
a programmable processor;
a driving mechanism circuit connected to the driving mechanism, wherein the driving mechanism circuit is to control the driving mechanism in response to receipt of instructions from the programmable processor; and
an input/output interface, wherein the programmable processor is to initiate a communication to another control circuit in another apparatus through the input/output interface.

6. The apparatus according to claim 5, wherein the programmable processor is to output a detected position of the first elongated member to the another control circuit and to receive, from the another control circuit, a detected position of another first elongated member in the another apparatus.

7. A system comprising:
a first mount;
a first strut rotatably connected to the first mount;
a second strut rotatably connected to the first mount;
wherein each of the first strut and the second strut includes:
a first member and a second member, the first member having a first end and a second end, wherein at least a portion of the second member is inserted into the first member through the second end;
a driving mechanism to move the first member linearly with respect to the second member to vary a distance between the first end of the first member and the second member; and
a control circuit housed within the second member, wherein the control circuit is to control the driving mechanism and vary a position of the first end with respect to the second elongated member, and wherein the control circuit in the first strut is to initiate a communication with the control circuit in the second strut to establish a network between the first strut and the second strut.

8. The system according to claim 12, wherein the second member of each of the first strut and the second strut has a top end and a bottom end, the system further comprising:
a second mount, wherein the first ends of the first members in each of the first strut and the second strut are rotatably connected to the first mount and the bottom ends in each of the first strut and the second strut are rotatably connected to the bottom mount.

9. The system according to claim 7, wherein the network between the first strut and the second strut is a peer-to-peer network and wherein the control circuits in each of the first strut and the second strut are to communicate data to each other to enable the control circuits in each of the first strut and the second strut to operate in at least one of a sequenced, synchronized, and coordinated manner with each other without external control.

10. The system according to claim 7, wherein each of the first strut and the second strut further includes a respective load cell to detect a physical load being applied onto the first strut and the second strut, wherein each of the load cells is to communicate the detected physical load to the respective control circuit of the first strut and the second strut.

11. The system according to claim 10, wherein the control circuits in each of the first strut and the second strut are to control the respective driving mechanisms in the first strut and the second strut according to a programmed routine, wherein the control circuits are to learn respective sequences of movements based upon physical loads detected by the load cell over a sequence of time and to program the respective routines to duplicate the respectively learned sequence of movements over the selected periods of time.

12. The system according to claim 10, wherein each of the load cells is to detect whether the physical load is being applied in a first direction or a second direction, and wherein each of the control circuits is to control the respective driving mechanism to move the first member in one of the first direction and the second direction according to the direction in which the physical load is detected to be applied.

13. The system according to claim 7, wherein the first strut includes a first position sensor having a coil that extends around a circumference of the second elongated member of the first strut, wherein a position of the first elongated member is to vary an inductance of the coil when a current is supplied through the coil, and wherein the control circuit is to determine a position of the first elongated member with respect to the second elongated member based upon the detected inductance of the coil

14. The system according to claim 7, wherein each of the control circuits comprises:
a programmable processor;
a driving mechanism circuit connected to the driving mechanism, wherein the driving mechanism circuit is to control the driving mechanism in response to receipt of instructions from the programmable processor; and
an input/output interface, wherein the programmable processor is to communicate with the other control circuit through the input/output interface.

15. A method for controlling an apparatus having a first member and a second member, wherein the second member is partially inserted into the first member, said method comprising:
receiving, by a control circuit in the apparatus, a detected physical load on the apparatus from a load cell positioned at an end of the second member located distally opposite the first member;
controlling, by the control circuit, a driving mechanism to rotate in a first direction in response to the physical load being a compressive load;
controlling, by the control circuit, the driving mechanism to rotate in a second direction in response to the physical load being a tensile load, wherein rotation of the driving mechanism in the first direction causes the second member to be inserted deeper into the first member and rotation of the driving mechanism in the second direction causes the second member to be drawn out from the first member; and
at least one of communicating, by the control circuit, data generated by the control circuit to another control circuit in another apparatus and receiving data from the other control circuit in the another apparatus to enable the control circuit and the another control circuit to operate in at least one of a sequenced, synchronized, and coordinated manner with each other without external control.
